(19) United States
(12) Patent Application Publication
(10) Pub. No.: US 2017/0305761 A1
(43) Pub. Date: Oct. 26, 2017

(54) Flow Modifier Baffles and Fluid Treatment System Comprising Same

(71) Applicant: Trojan Technologies, London (CA)

(72) Inventors: Dusko Antonio KEZELE, London (CA); Jim FRASER, St. Thomas (CA); Gregory Scott WARKENTIN, Parkhill (CA)

(21) Appl. No.: 15/513,261

(22) PCT Filed: Sep. 22, 2015
(86) PCT No.: PCT/CA2015/050929

§ 371 Date: Mar. 22, 2017

Related U.S. Application Data
(60) Provisional application No. 62/071,348, filed on Sep. 22, 2014.

(51) Int. Cl. C02F 1/32; F15D 1/00; B01J 19/00; B01J 19/12

(52) U.S. Cl. CPC C02F 1/325; B01J 19/123; F15D 1/0005; B01J 19/006; B01J 2219/00768; B01J 2219/1203; C02F 2201/328; B01J 2219/0877

(57) ABSTRACT

Described is a baffle comprising a continuous outer edge and an interior portion enclosed by the outer edge and connected to the outer edge. The interior portion comprises one or more teeth each having a tip directed towards the centre of the baffle, a base adjacent to the outer edge, and a tooth edge joining the tip to the base, wherein at least a portion of the tooth edge defines at least a portion of an aperture extending from a first face to a second face of the baffle.

### CROSS-REFERENCE TO RELATED APPLICATION

The present application claims the benefit under 35 U.S.C. §119(e) of provisional patent application Ser. No. 62/071,348, filed Sep. 22, 2014, the contents of which are hereby incorporated by reference.

### BACKGROUND OF THE INVENTION

### Field of the Invention

In one of its aspects, the present invention relates to a baffle for use in a fluid treatment device. In another one of its aspects, the present invention relates to a method of treating fluid.

### Description of the Prior Art

Ultraviolet (UV) treatment of water is typically performed by either low pressure or medium pressure mercury-arc lamps emitting either 185 nm to 254 nm wavelength light, depending on the application (e.g., environmental contaminant treatment or disinfection). With either type of lamp, existing UV reactors typically employ regularly shaped baffles to divert flow at or close to lamps. The baffles are solid up to a specific distance from the walls of the reactor.

### SUMMARY OF THE INVENTION

It is an object of the present invention to obviate or mitigate at least one of the above-mentioned disadvantages of the prior art.

It is another object of the present invention to provide a novel baffle.

It is another object of the present invention to provide a novel fluid treatment device.

It is another object of the present invention to provide a novel method for treating a fluid with light.

Accordingly, in one of its aspects, the present invention provides a baffle comprising a continuous outer edge and an interior portion enclosed by the outer edge and connected to the outer edge, wherein the interior portion comprises a plurality of tooth-shaped portions, each tooth-shaped portion comprising: (i) a tip portion directed towards the centre of the baffle, (ii) a base portion adjacent to the outer edge, and (iii) a tooth edge joining the tip portion to the base portion, wherein at least a portion of the tooth edge defines at least a portion of an aperture extending from a first face to a second face of the baffle.

In another of its aspects, the present invention provides a fluid treatment device comprising an inlet for untreated fluid to enter the device, an outlet for treated fluid to exit the device, a housing, one or more light-emitting lamps, and one or more baffles disposed within the housing, at least one baffle of the one or more baffles comprising a continuous outer edge and an interior portion enclosed by the outer edge and connected to the outer edge, wherein the interior portion comprises a plurality of tooth-shaped portions, each tooth-shaped portion comprising: (i) a tip portion directed towards the centre of the baffle, (ii) a base portion adjacent to the outer edge, and (iii) a tooth edge joining the tip portion to the base portion, wherein at least a portion of the tooth edge defines at least a portion of an aperture extending from a first face to a second face of the baffle, and wherein the aperture receives the one or more light-emitting lamps.

In yet another of its aspects, the present invention provides a method of treating a fluide, the method comprising: feeding untreated fluid into the housing of the fluid treatment device defined in the previous paragraph (including its preferred embodiments; passing the untreated fluid through the aperture; and irradiating the untreated fluid with radiation emitted from light-emitting lamp

Thus, the present inventors have recognized that the flow field within a UV reactor system can be modified to match the light intensity field of interest (for example, 254 nm for disinfection or 185 nm for destruction of environmental contaminants).

One preferred embodiment of the present invention is the use of a toothed baffle to approximate an ideal velocity profile of a fluid in a single-lamp flow reactor, a multi-lamp parallel flow reactor, or a multi-lamp cross-flow reactor.

An advantage of implementing the presently described baffle is that reactor efficiency (e.g., dose delivery relative to input power) is increased over existing baffle designs, while power losses due to reactor wall absorption of light are simultaneously minimized by allowing the reactor shell to increase in size. The use of baffles according to the present invention to modify fluid flow in a reactor, in combination with a relatively large reactor shell, can also result in a low head loss arrangement and may outperform existing reactors in terms of delivered dose per unit hydraulic resistance. Other advantages of the invention will become apparent to those of skill in the art upon reviewing the present specification.

### BRIEF DESCRIPTION OF THE DRAWINGS

Embodiments of the present invention will be described with reference to the accompanying drawings, wherein like reference numerals denote like parts, and in which:

FIG. 1(a) is a side perspective view of a fluid treatment device with a single lamp configuration and conventional baffles as is known in the art;

FIG. 1(b) is a top perspective view of a fluid treatment device with a double lamp configuration and conventional baffles as is known in the art;

FIG. 2(a) is a side perspective view of a fluid treatment device having a single lamp configuration and toothed baffles according to an embodiment of the invention;

FIG. 2(b) is a top perspective view of a fluid treatment device having a double lamp configuration and toothed baffles according to an embodiment of the invention;

FIG. 3(a) is a top perspective view of a fluid treatment device having baffles with triangular-shaped teeth according to an embodiment of the invention;

FIG. 3(b) is a side perspective view of a fluid treatment device having baffles with trapezoidal-shaped teeth according to an embodiment of the invention;

FIG. 4 illustrate an example of a velocity profile modified within a single lamp reactor: (a) shows basic configuration of saw-tooth baffles, (b) shows CFD results of velocity profile as modified by saw-tooth baffles;

FIG. 5 is a graph illustrating typical intensity field radiating outward from a lamp through a fluid layer with a UVT of 95%;

FIG. 6 is a graph illustrating a comparison between the ideal velocity profile to achieve a target dose of 55.8 mJ/cm² for a specific annular reactor configuration (solid trace); velocity profile with saw-tooth baffles (fine dashed trace); and velocity profile for conventional baffles (coarse dashed trace);

FIG. 7 is a graph illustrating a comparison of the dose distributions corresponding to the velocity profiles from FIG. 6: ideal velocity profile (solid trace), saw-tooth baffles (finer hashed trace), conventional baffles (coarser hashed trace);

FIG. 8 illustrates saw-tooth baffles applied to a multi-lamp parallel flow reactor: (a) shows basic configuration, and (b) shows CFD Results of velocity profile as modified by saw-tooth baffles;

FIG. 9 illustrates a saw-tooth baffle in a single lamp reactor;

FIG. 10 illustrates a saw-tooth baffle in a multiple lamp parallel to flow reactor; and

FIG. 11 illustrates a saw-tooth baffle in a multiple lamp transverse to flow reactor.

### DETAILED DESCRIPTION OF THE PREFERRED EMBODIMENTS

In one of its aspects, the present invention provides a a baffle comprising a continuous outer edge and an interior portion enclosed by the outer edge and connected to the outer edge, wherein the interior portion comprises a plurality of tooth-shaped portions, each tooth-shaped portion comprising: (i) a tip portion directed towards the centre of the baffle, (ii) a base portion adjacent to the outer edge, and (iii) a tooth edge joining the tip portion to the base portion, wherein at least a portion of the tooth edge defines at least a portion of an aperture extending from a first face to a second face of the baffle. Preferred embodiments of this process may include any one or a combination of any two or more of any of the following features:
the tooth edge of tooth-shaped portion extends to the outer edge;
the base of the tooth-shaped portion is defined by the outer edge;
the base of tooth-shaped portion is displaced radially from the outer edge;
the tooth-shaped portion is substantially triangular-shaped;
the tooth-shaped portion is substantially trapezoidal-shaped;
the baffle is configured to be substantially planar;
the baffle comprises a plurality of tooth-shaped portions is arranged annularly or non-annularly about the centre of the baffle;
each tooth-shaped portion in the plurality of tooth-shaped portions has substantially the same shape; and/or
the radial angle of each tooth of the plurality of tooth-shaped portions is substantially the same.

In another of its aspects, the present invention relates to a fluid treatment device comprising an inlet for untreated fluid to enter the device, an outlet for treated fluid to exit the device, a housing, one or more light-emitting lamps, and one or more baffles disposed within the housing, at least one baffle of the one or more baffles comprising a continuous outer edge and an interior portion enclosed by the outer edge and connected to the outer edge, wherein the interior portion comprises a plurality of tooth-shaped portions, each tooth-shaped portion comprising: (i) a tip portion directed towards the centre of the baffle, (ii) a base portion adjacent to the outer edge, and (iii) a tooth edge joining the tip portion to the base portion, wherein at least a portion of the tooth edge defines at least a portion of an aperture extending from a first face to a second face of the baffle, and wherein the aperture receives the one or more light-emitting lamps.

Preferred embodiments of this use may include any one or a combination of any two or more of any of the following features:
the tooth edge of the tooth-shaped portion of the at least one baffle extends to the outer edge;
the base of the tooth-shaped portion of the at least one baffle is defined by the outer edge;
the base of the tooth-shaped portion of the at least one baffle is displaced radially from the outer edge;
the tooth-shaped portion of the at least one baffle is substantially triangular-shaped;
the tooth-shaped portion of the at least one baffle is substantially trapezoidal-shaped;
the device of claim 16 comprising a plurality of light-emitting lamps;
the at least one baffle is substantially planar
the light-emitting lamp is UV radiation emitting lamp;
the device is configured as a single-lamp reactor;
the device is configured as a multi-lamp parallel flow reactor;
the device is configured as a cross-flow reactor;
the device further comprises a wiper sleeve mechanism;
the device receives fluid from the input;
the fluid flows through the aperture of the one or more baffles as the fluid flows from the input towards the output;
the housing comprises a housing wall having an interior surface and an exterior surface, and wherein the outer edge of the one or more baffles contacts the interior surface of the housing wall;
the velocity of the flow of fluid through the aperture varies along a radius extending from the centre of the aperture to the interior surface of the housing wall;
the velocity of the flow of fluid through the aperture is reduced at a point on the radius relatively closer to the housing wall than a second point along the radius;
the baffle comprises a plurality of tooth-shaped portions is arranged annularly or non-annularly about the centre of the baffle; and/or
each tooth-shaped portion in the plurality of tooth-shaped portions has substantially the same shape.

The device of claim 29 or claim 30 wherein the radial angle of each tooth of the plurality of tooth-shaped portions is substantially the same.

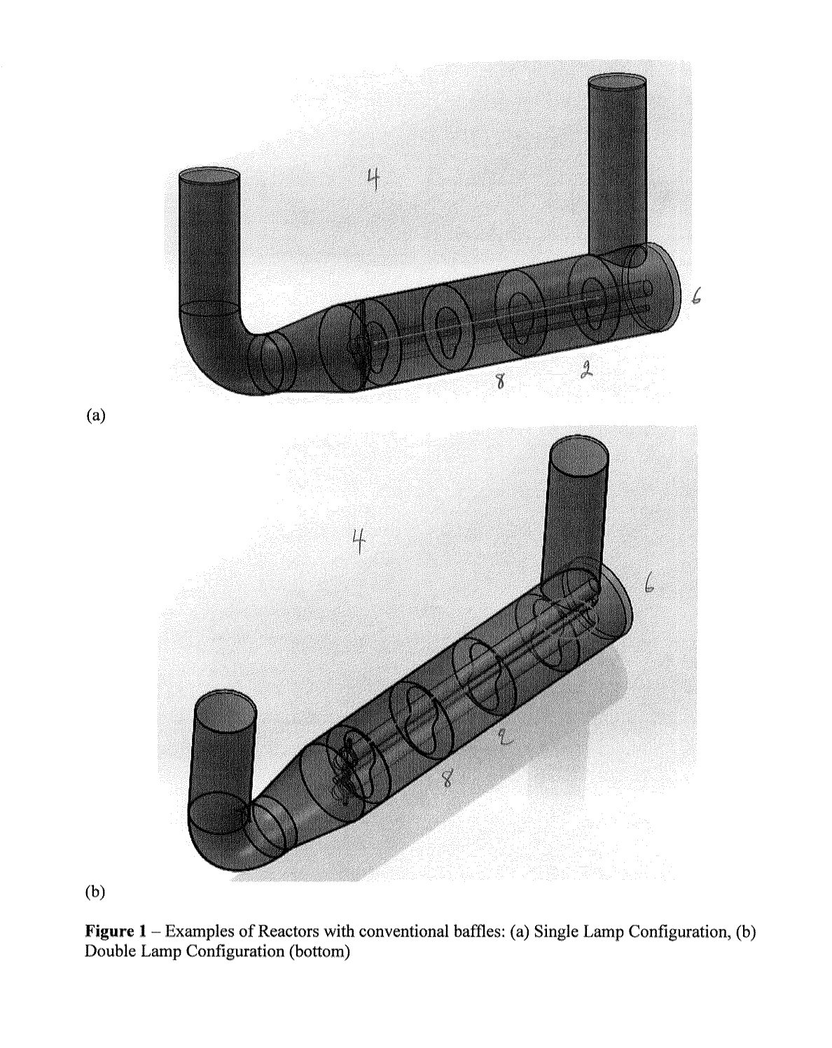

FIGS. 1(a) and 1(b) show baffles 2 known in the art for use in low pressure and medium pressure lamp reactors. FIG. 1(a) depicts a reactor 4 with regularly interspaced baffles 2 having apertures 8 through which a lamp 6 extends. FIG. 1(b) shows a dual-lamp reactor 4 having baffles 2 with an extended aperture 8 accommodating two lamps 6. Each baffle 2 of the reactors 4 directs the flow of fluid past the high-intensity UV lamps 6. The baffles 2 typically comprise a flat plate with a single rounded aperture 8 to redirect flow at the higher intensity regions of the lamp 6. Each aperture 8 constricts the fluid flow to produce a single concentrated stream or jet of fluid aimed at the high intensity region of the lamp 6 or lamps 6 in the case of multi-lamp reactors 4.

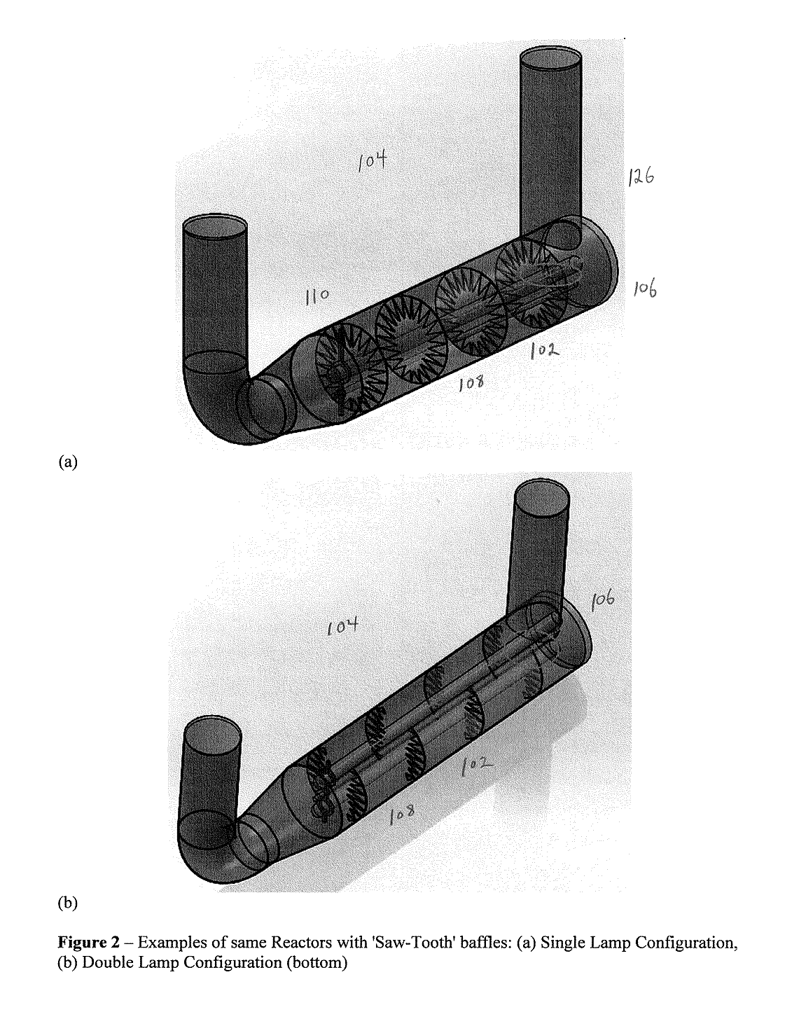

Referring to FIGS. 2(a) and 2(b), examples of fluid treatment devices 104 housing toothed baffles 102 according to an embodiment of the invention are shown. FIG. 2(a) depicts a fluid treatment device 104 comprising regularly interspaced baffles 102 having apertures 108 through which a lamp 106 extends. FIG. 2(b) shows a dual-lamp fluid treatment device 104 having baffles 102 with an extended aperture 108 accommodating the two lamps 106. In the embodiments shown in FIGS. 2(a) and 2(b), each baffle 102 is constructed of multiple “saw-tooth” plates each with a contoured shape to form a plurality of teeth 110 which direct the flow of fluid past the high intensity lamp 106 in a more refined manner relative to baffles in the prior art. As described further below, the toothed design (e.g., “saw” or “shark” shape) of each tooth 110 of a baffle 102 allows the velocity profile of the fluid to more precisely match the light intensity field around the lamp 106, resulting in a more uniform dose distribution and hence a more efficient fluid treatment device.

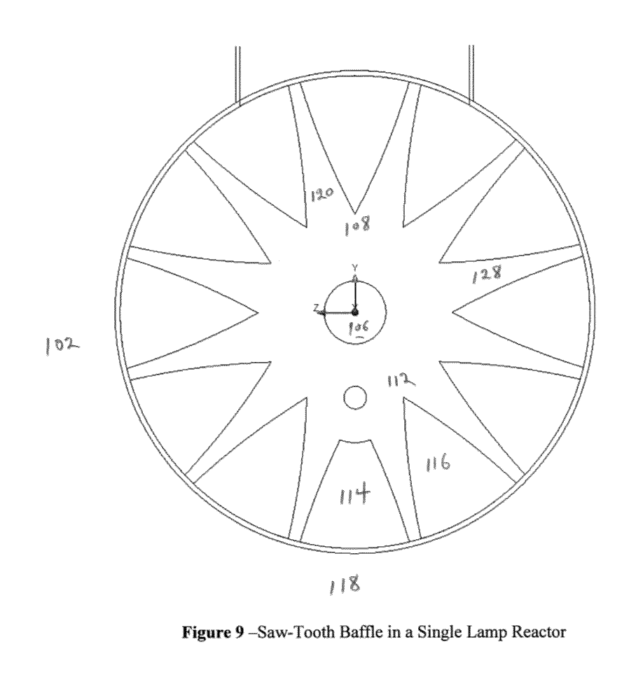

Referring to FIG. 9, each tooth 110 comprises a tip 112 directed towards the centre of the baffle 102, a base 116 adjacent to an outer edge 118 and defining the peripheral boundary of the tooth 110, and a tooth edge 114 connecting the tip 112 to the base 116. Each tooth edge 114 defines a portion of the aperture 108, which in FIG. 9 includes the area adjacent to the lamp 106 as well as the gaps 128 between teeth 110. In FIG. 9, the tooth edge 114 of each tooth 110 extends to the outer edge 118 of the baffle 102, and the base 116 of the tooth 110 is defined by the outer edge 118. However, this need not be the case. In some embodiments the tooth edge 114 may not extend to the outer edge 118 of the baffle 102 but instead terminate at some distance radially inward of the outer edge 118. In these embodiments, the peripheral boundary of the tooth 110 (i.e., the base 116) will not be at the outer edge 118 but instead will be shifted radially inward. In these cases the base 116 is defined by a line made parallel to the outer edge 118 joining one end of the tooth edge 114 to the other end of the tooth edge 114.

As shown in FIG. 9, the baffle 102 comprises an interior portion 120 comprising the teeth 110 and an outer portion comprising the outer edge 118. The interior portion 120 can also include non-teeth material (for example, when the base 116 of one or more teeth 110 of the baffle 102 do not extend to the outer edge 118). The interior portion 120, including each tooth 110, is typically planar (i.e., defining a plane) with two opposed faces connected at the outer edge 118, tooth edge 114, and tip 112. As will be understood, the aperture 108 extends through the baffle 102 transversely to the plane of the baffle from one face to the opposed face. Typically the baffle 102 is disc-shaped (i.e., the outer edge 118 of the baffle 102 defines a circle or oval), although other shapes of the baffle 102 such as square or triangular are contemplated.

The teeth 110 of the baffle 102 can be formed by any means known to a person skilled in the art. For example, each tooth 110 can be formed from a separate plate which is fastened to the outer edge 118 or to adjacent teeth 110 by one or more welds. Alternatively, teeth 110 of the baffle 102 can be machined as part of a single plate. The number of teeth 110 on a baffle 102 can vary from one tooth 110 to many teeth 110.

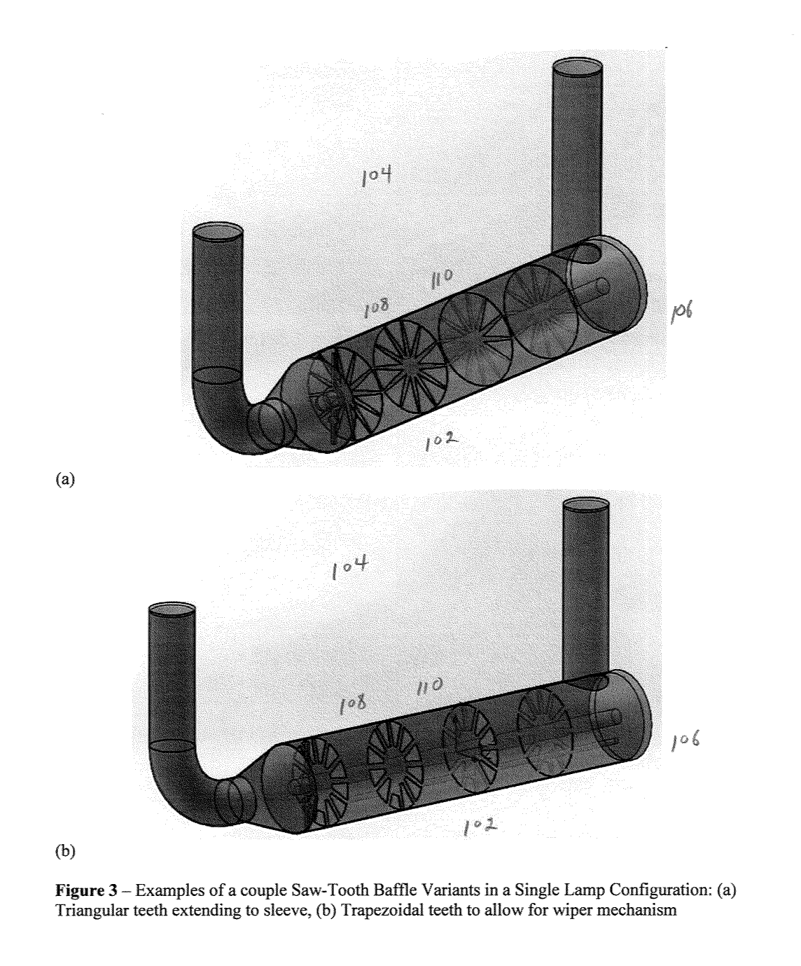

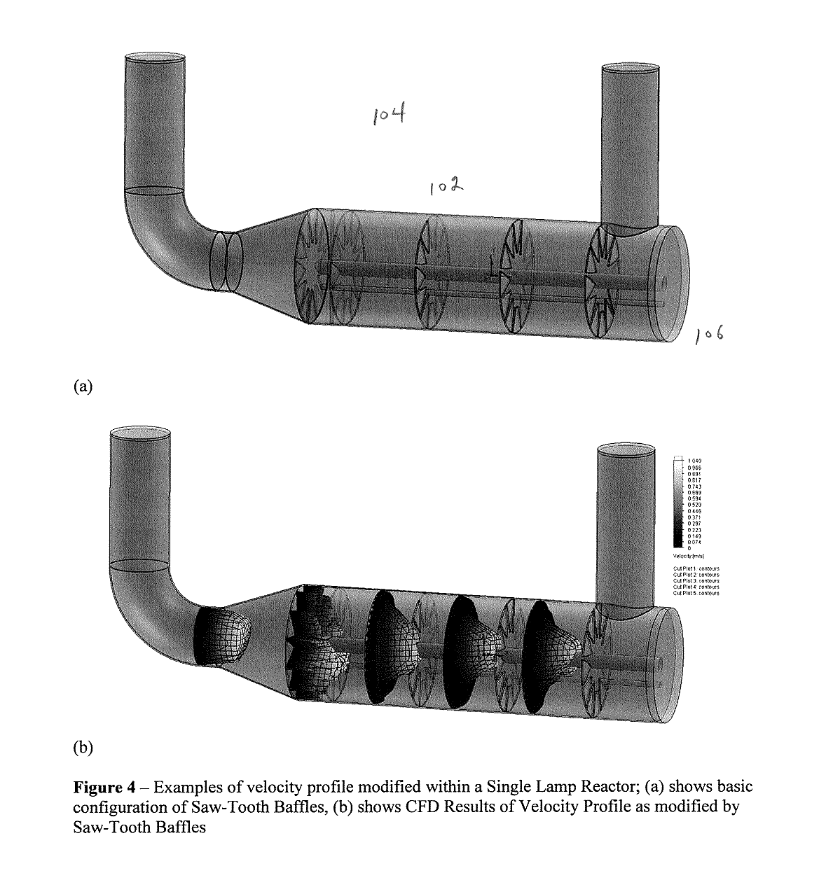

In FIGS. 2(a) and 2(b), the shapes of teeth 110 are triangular shaped (i.e., “saw-toothed”). However, the shapes of teeth 110 can vary and need not be triangular/saw-tooth-shaped. For example, FIG. 3(b) shows trapezoidal-shaped teeth. The shape of teeth 110 in a single baffle 102 can vary, and/or the shape of teeth in different baffles 102 of the same fluid treatment device 104 can vary. For example, it may be desirable to use trapezoidal-shaped teeth, to accommodate an additional structure such as the drive for a cleaning system.

The distance from the tip 112 to the base 116 (i.e., the length of the tooth) can also vary.

FIG. 3(a) shows teeth 110 having tips 112 positioned directly adjacent the sleeve of the lamp 106 and bases 116 defined by the outer edge 118 of the baffle 102. In such an embodiment, maximum modification of the fluid velocity profile in the fluid treatment device 104 can be achieved, as the fluid velocity profile is regulated (i.e., by the existence of gaps 128 between the teeth 110) from directly adjacent the lamp 106 to the walls of the fluid treatment device 104.

In contrast, FIG. 3(b) shows teeth 110 having tips 112 which are radially separated from the sleeve of the lamp 106 and bases defined by the outer edge 118. In some embodiments, shorter teeth exist to allow for sufficient clearance for a wiper mechanism (e.g., mounted on the outside of the sleeve of the lamp 106 for cleaning the sleeve) or other internal components spanning across the baffle 102. It will be evident from the above that the length of the teeth 110 will typically inversely correlate with the total area of the aperture 108.

In preferred embodiments, the radial angle of each tooth 110 of the baffle 102 is substantially the same (herein the term “substantially” when used to describe an angle refers to a deviation of)±5°. The radial angle of a tooth 110 is defined as the fraction of the circumference of a circle drawn to include the base 116 as part of the circumference that is occupied by the base 110. For example, where the base 116 is defined by the outer edge 118 of the baffle 102, the radial angle of the tooth 110 is the fraction of the 360 degree perimeter of the baffle 102 which is occupied by the base 116 of the tooth 110. In some embodiments the radial angles of different teeth 110 of the same baffle 102 vary, and/or the radial angles of teeth 110 on different baffles 102 of the same fluid treatment device 104 vary.

In operation, one or more baffles 102 can be disposed in a housing 124 of a fluid treatment device 104 in a manner known to a person skilled in the art. For example, the housing 104 can comprise one or more removable mounting plates 126 (shown in FIG. 2(a)) which when removed allow access to the interior of the fluid treatment device 104. By removing the mounting plate 126, one or more lamps 106 can be inserted through the apertures 108 of one or more baffles 102 along the length of the housing 124. Each baffle 102 can be supported in the housing by means known in the art (e.g., one or more braces extending longitudinally along the length of the fluid treatment device). Typically the outer edge 118 of each baffle 102 will contact an interior surface of a wall of the housing 124. The fluid treatment device 104 typically comprises the housing 124, one or more baffles 102 and lamps 106 secured within the housing 124, a fluid inlet for receiving untreated fluid and a fluid outlet through which treated fluid exits the device. Fluid entering the fluid treatment device 104 is typically pressurized and is treated along the length of the device 104 by ultraviolet light emitted by the one or more lamps 106. As the pressurized fluid flows through the apertures 108 of the baffles 102, the fluid is brought into various degrees of proximity to high-intensity UV light emitted from the one or more lamps 106.

With respect to the mechanics of operation of a fluid treatment device 104 comprising one or more baffles 102, the toothed design of each baffle 102 allows the flow field of a fluid to be modified to substantially match the light intensity field of interest (e.g., 254 nm for disinfection; 185 nm for destruction of environmental contaminants). This is in contrast to untoothed baffles 2 known in the art (e.g., FIGS. 1(a) and 1(b)), where no mechanism is in place to harmonize the flow field of the fluid with the light intensity field.

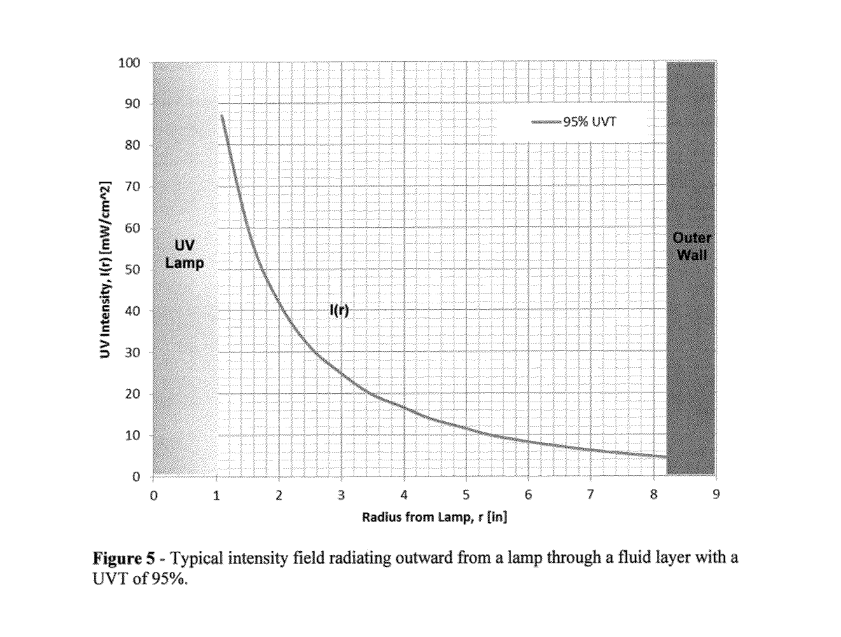

FIG. 5 shows a typical intensity field radiating outward from a lamp through the fluid layer with a UVT of 95%. The intensity field is rotationally symmetric and drops off significantly with radial distance from lamp. The intensity field would be similar at other UVT values. If we let the intensity field be represented by radial function, I(r), lamp length, L and a desired target dose, Dt, we can define an Ideal Velocity Profile, v(r), for a fluid treatment device 104 can be defined.

Assuming that fluid particle trajectories are predominantly parallel to the lamp 106, the required retention time t(r) can be defined as a function of radial distance from the lamp:

$$t ( r ) = \frac{Dt}{I ( r )} \qquad ( 1 )$$

The ideal velocity profile can be written as:

$$v ( r ) = \frac{L}{t ( r )} \qquad ( 2 )$$

Substituting t(r) into v(r) gives:

$$v ( r ) = \frac{I ( r ) L}{Dt} \qquad ( 3 )$$

Equation 3 can then be used to define the Ideal Velocity Profile for a single-lamp, annular fluid treatment device.

In practice, the ideal velocity profile is difficult to achieve in real reactors due to wall friction and boundary layer effects which force the velocity at the lamp and the outer wall to diminish to zero. However, CFD simulations have been used to show that the saw-tooth baffle of the present invention can be used to approach closer to the ideal velocity profile as compared to conventional baffles.

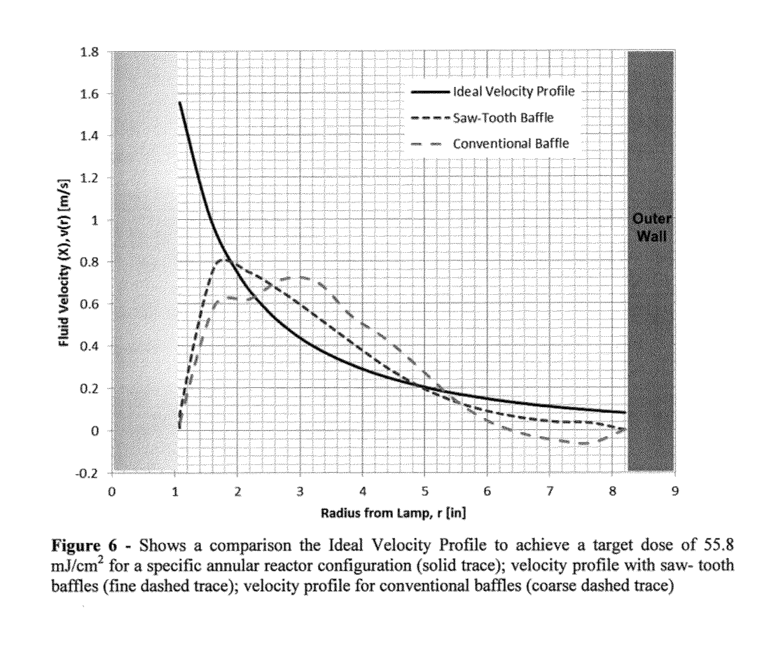

For example, FIG. 6 shows a comparison of an ideal velocity profile computed for specific annular reactor to achieve a target average dose of 55.8 mJ/cm² (solid trace). Also shown in FIG. 6 are velocity profiles produced by Saw-Tooth Baffles (fine dashed trace) and conventional baffles (coarse dashed trace). The longitudinal (X direction) component of velocity is used for the comparison to demonstrate the effect since the velocity X predominates in this example. It will be apparent that the saw-tooth baffles produce a velocity profile that is closer to that of the ideal velocity profile as compared to the conventional baffles. Those of skill in the art will appreciate that the shape of the saw-tooth baffles can be tuned to further improve the velocity profile to better match the ideal velocity profile. Those of skill in the art will further appreciate that the above principle of operation will work for both single- and multi-lamp parallel flow reactor configurations. A similar approach also applies to cross flow reactors.

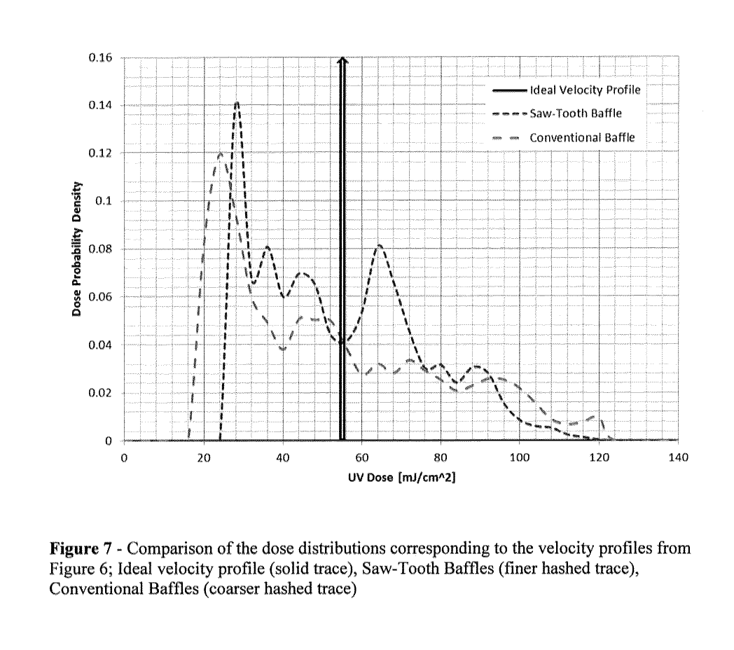

To further demonstrate the principle of operation, FIG. 7 shows a comparison of the dose-distributions corresponding to the velocity profiles of saw-tooth baffles, conventional baffles from FIG. 6 to that of the ideal velocity profile. It can be seen that the dose distribution produced by an ideal velocity profile in theory would result in a spike at the target dose 55.8 mJ/cm² (solid trace) while the reactor with the conventional baffles produces a broad distribution (coarse dashed trace). The reactor with the saw-tooth baffles (fine dashed trace) results in a narrower distribution, thereby demonstrating the principle. Since the breadth (i.e., spread) of the dose-distribution is related to the efficiency of the reactor the saw-tooth baffles results in a significant improvement in reactor efficiency. A higher efficiency means that a higher proportion of fluid particles achieve a dose closer to the target average dose 55.8 mJ/cm²).

Table 1 shows CFD results for the examples cited above at the same operating conditions. The narrower dose-distribution of the Saw-Tooth Baffle results in improved disinfection performance as indicated by the higher RED value. Table 2 shows a reduced data set if needed to be disclosed in Patent.

Those of skilled in the art will appreciate that it would be possible to employ the above principle of operation for both single and multi-lamp parallel flow reactor configurations.

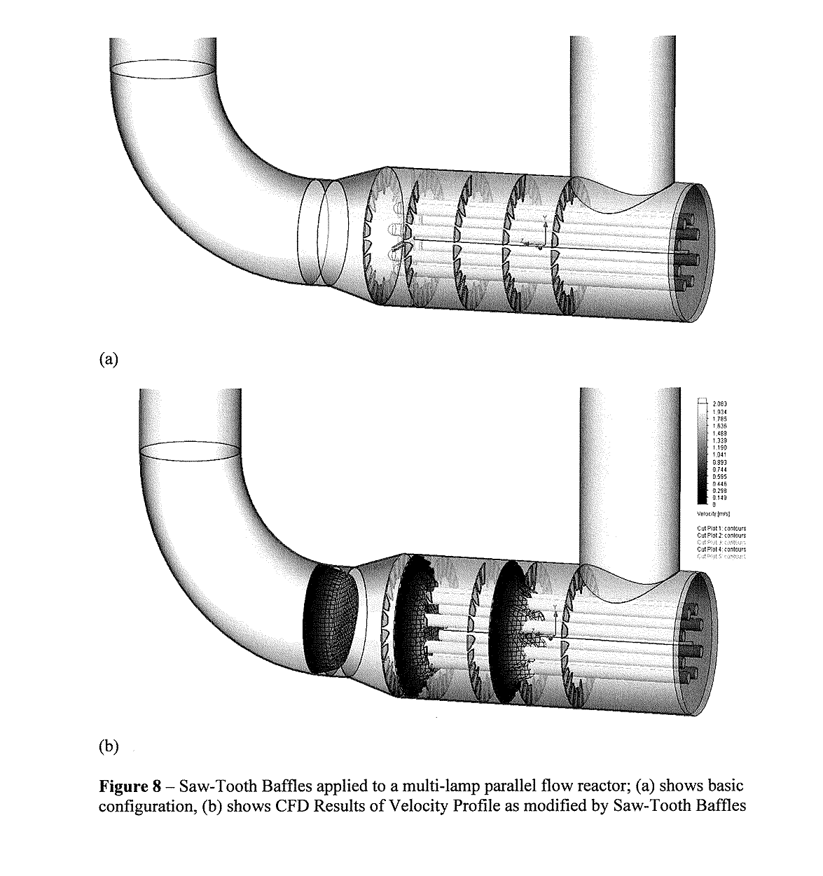

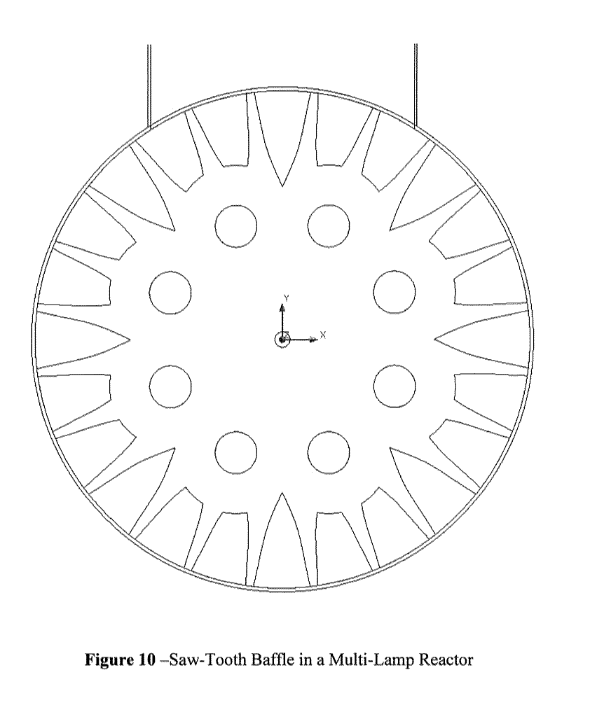

In the case of multi-lamp reactors, FIGS. 8 and 10 shows an example of tooted baffles 102 (e.g., saw-tooth baffles) applied to a multi-lamp parallel flow reactor 104. A significantly notable advantage of locating the toothed baffles 102 (e.g., saw-tooth baffles) on the periphery of the grouping the lamps 106 is to allow the unobstructed operation of a common wiper mechanism while still allowing higher reactor efficiencies to be achieved. Those proficient in the art of reactor design can optimize the saw-tooth baffles in a variety of multi-lamp parallel flow reactor configurations.

The following parameters may be varied and tuned to optimize the flow field to match the radiation intensity field within the fluid treatment vessel:

Number of “teeth” or plates
regular rotational pattern;
irregular rotational pattern; and
gap distance between plates.

Shape of “teeth” or plates
number of sides;
curvature of sides; and
orientation of truncation.

Size of “teeth” or plates
width of base;
height of apex or tip; and
width and height of truncation.

Porosity
perforation; and
striations.

Structural rigidity
rib reinforced; and
web reinforced.

The preferred embodiment of the present baffles comprises one or any two or more of the following features:
12-24 “teeth” or plates on periphery;
regular rotational pattern;
3 sided and 4 sided shape;
gap distance 0 to 20 mm (2 to 15 mm preferred);
height to apex 2.5 to 500 mm (25 to 250 mm preferred); and
width of base 1.5 to 300 mm (15 to 150 mm preferred)

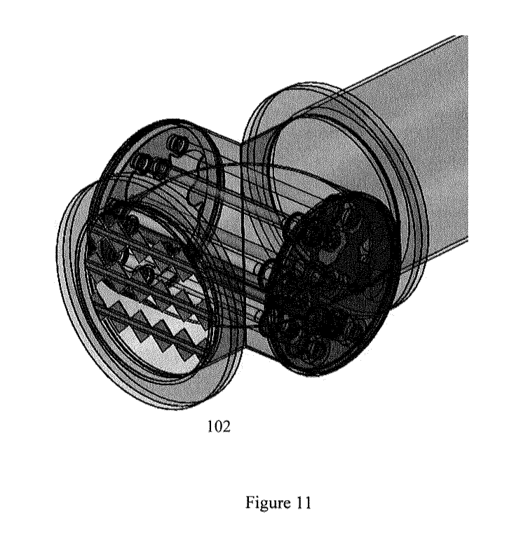

The present toothed baffle (e.g., saw toothed baffle) in a cross flow reactor can provide an aperature opening that modifies the velocity field such that it provides a velocity gradient that matches the intensity gradients produced by the downsream lamps; the resulting effect is similar to cross flow as in parallel flow lamps. Thus, it is possible to modify the above-described embodiments focussed on parallel to flow lamp orientation to a reactor in which the lamps are transverse (e.g., orthogonal or otherwise angled) with respect to the direct of fluid flow through the reactor. An example of such an approach is illustrated in FIG. 11.

While this invention has been described with reference to illustrative embodiments and examples, the description is not intended to be construed in a limiting sense. Thus, various modifications of the illustrative embodiments, as well as other embodiments of the invention, will be apparent to persons skilled in the art upon reference to this description. For example, reference has been made throughout this specification to tooth-shaped portions. Those of skill in the art will recognize that ‘toothed’, ‘saw-tooth’, ‘fin-shaped’ or ‘petal-shaped’ are equivalent descriptors for “tooth-shaped” portions. It is therefore contemplated that the appended claims will cover any such modifications or embodiments.

All publications, patents and patent applications referred to herein are incorporated by reference in their entirety to the same extent as if each individual publication, patent or patent application was specifically and individually indicated to be incorporated by reference in its entirety.

TABLE 1
CFD Results demonstrating improved disinfection performance of Saw-Tooth Baffles

| | Q | UVT | MS2 D10 | ID | AD | RED | | | | HL |
|---|---|---|---|---|---|---|---|---|---|---|
| Case | [MGD] | [%] | [mJ/cm\hat{ }2] | [mJ/cm\hat{ }2] | [mJ/cm\hat{ }2] | [mJ/cm\hat{ }2] | RED/ID | RED/AD | AD/ID | [m] |
| 1) Saw Tooth Baffles | 0.65 | 0.95 | 20 | 102.5 | 55.8 | 40.9 | 0.40 | 0.73 | 0.54 | 0.109 |
| 2) Conventional Baffles | 0.65 | 0.95 | 20 | 102.5 | 55.2 | 34.0 | 0.33 | 0.62 | 0.54 | 0.091 |

TABLE 2
CFD Results demonstrating improved disinfection performance of Saw-Tooth Baffles

| | Q | UVT | MS2 D10 | AD | RED | | HL |
|---|---|---|---|---|---|---|---|
| Case | [MGD] | [%] | [mJ/cm\hat{ }2] | [mJ/cm\hat{ }2] | [mJ/cm\hat{ }2] | RED/AD | [m] |
| 1) Saw Tooth Baffles | 0.65 | 0.95 | 20 | 55.8 | 40.9 | 0.73 | 0.109 |
| 2) Conventional Baffles | 0.65 | 0.95 | 20 | 55.2 | 34.0 | 0.62 | 0.091 |

1. A baffle comprising a continuous outer edge and an interior portion enclosed by the outer edge and connected to the outer edge, wherein the interior portion comprises a plurality of tooth-shaped portions, each tooth-shaped portion comprising: (i) a tip portion directed towards the centre of the baffle, (ii) a base portion adjacent to the outer edge, and (iii) a tooth edge joining the tip portion to the base portion, wherein at least a portion of the tooth edge defines at least a portion of an aperture extending from a first face to a second face of the baffle.

2. The baffle of claim 1, wherein the tooth edge of tooth-shaped portion extends to the outer edge.

3. The baffle of claim 1, wherein the base portion of the tooth-shaped portion is defined by the outer edge.

4. The baffle of claim 1, wherein the base portion of the tooth-shaped portion is displaced radially from the outer edge.

5. The baffle of any one of claim 1, wherein the tooth-shaped portion is substantially triangular-shaped.

6. The baffle of claim 1, wherein the tooth-shaped portion is substantially trapezoidal-shaped.

7. The baffle of claim 1 configured to be substantially planar.

8-10. (canceled)

11. A fluid treatment device comprising an inlet for untreated fluid to enter the device, an outlet for treated fluid to exit the device, a housing, one or more light-emitting lamps, and one or more baffles disposed within the housing, at least one baffle of the one or more baffles comprising a continuous outer edge and an interior portion enclosed by the outer edge and connected to the outer edge, wherein the interior portion comprises a plurality of tooth-shaped portions, each tooth-shaped portion comprising: (i) a tip portion directed towards the centre of the baffle, (ii) a base portion adjacent to the outer edge, and (iii) a tooth edge joining the tip portion to the base portion, wherein at least a portion of the tooth edge defines at least a portion of an aperture extending from a first face to a second face of the baffle, and wherein the aperture receives the one or more light-emitting lamps.

12. The fluid treatment device of claim 11, wherein the tooth edge of the tooth-shaped portion of the at least one baffle extends to the outer edge.

13. The fluid treatment device of claim 11, wherein the base portion of the tooth-shaped portion of the at least one baffle is defined by the outer edge.

14. The fluid treatment device of claim 11, wherein the base portion of the tooth-shaped portion of the at least one baffle is displaced radially from the outer edge.

15. The fluid treatment device of claim 11, wherein the tooth-shaped portion of the at least one baffle is substantially triangular-shaped.

16. The fluid treatment device of claim 11, wherein the tooth-shaped portion of the at least one baffle is substantially trapezoidal-shaped.

17. The fluid treatment device of claim 16 comprising a plurality of light-emitting lamps.

18. The fluid treatment device of claim 11, wherein the at least one baffle is substantially planar.

19. The fluid treatment device of claim 11, wherein the light-emitting lamp is a UV radiation emitting lamp.

20. The fluid treatment device of claim 11 configured as a single-lamp reactor.

21. The fluid treatment device of claim 11 configured as a multi-lamp parallel flow reactor.

22. The fluid treatment device of claim 11 configured as a cross-flow reactor.

23-31. (canceled)

32. A method of treating a fluid, the method comprising the steps of :
feeding untreated fluid into the housing of the fluid treatment device defined in claim 11;
passing the untreated fluid through the aperture; and
irradiating the untreated fluid with radiation emitted from light-emitting lamp.
